(19) United States
(12) Patent Application Publication
(10) Pub. No.: US 2019/0243362 A1
(43) Pub. Date: Aug. 8, 2019

(54) DRIVE MODE SWITCH CONTROLLER, SYSTEM, METHOD, AND PROGRAM

(71) Applicant: OMRON Corporation, Kyoto-shi (JP)

(72) Inventors: Tadashi HYUGA, Kyoto-shi (JP); Hiroshi SUGAHARA, Kyoto-shi (JP); Kazuyoshi OKAJI, Kyoto-shi (JP); Michie UNO, Kyoto-shi (JP); Koji TAKIZAWA, Kyoto-shi (JP)

(73) Assignee: OMRON Corporation, Kyoto-shi (JP)

(21) Appl. No.: 16/385,008

(22) Filed: Apr. 16, 2019

Related U.S. Application Data
(63) Continuation of application No. PCT/JP2017/033132, filed on Sep. 13, 2017.

(30) Foreign Application Priority Data
Mar. 10, 2017 (JP) 2017-046219

(51) Int. Cl. G05D 1/00; B60W 40/08; B60W 50/14; B60W 50/08; G06K 9/00

(52) U.S. Cl. CPC G05D 1/0061; B60W 40/08; B60W 50/14; B60W 2050/0002; G06K 9/00845; B60W 2040/0818; B60W 50/082

(57) ABSTRACT

A drive mode switch controller outputs a signal for switching from an automatic drive mode to a manual drive mode. An obtaining unit obtains sensing data indicating light intensity measured by a light intensity sensor, and stores the sensing data into a storage. A determination unit determines, based on the sensing data, whether a surrounding environment in the direction in which a vehicle travels satisfies a predetermined condition appropriate for switching the drive mode in a period predetermined for the switching. A signal output unit outputs a signal for performing the switching when the surrounding environment in the direction in which the vehicle travels is determined to satisfy the predetermined condition.

### CROSS REFERENCE TO RELATED APPLICATIONS

This application is a continuation application of International Application No. PCT/JP2017/033132, filed on Sep. 13, 2017, which claims priority based on the Article 8 of Patent Cooperation Treaty from prior Japanese Patent Application No. 2017-046219, filed on Mar. 10, 2017, the entire contents of which are incorporated herein by reference.

### FIELD

The disclosure relates to a drive mode switch controller, a drive mode switch control system, a drive mode switch control method, and a program for outputting a signal for switching the drive mode of a vehicle from an automatic drive mode to a manual drive mode.

### BACKGROUND

In addition to a manual drive mode for driving a vehicle with a driving operation performed by a driver, an automatic drive mode has been developed for driving a vehicle along a predetermined route without a driver performing a driving operation. The automatic drive mode enables automatic driving of a vehicle by controlling, for example, a power unit, a steering unit, and a brake based on information generated by a navigation system using a global positioning system (GPS), traffic information obtained through road-to-vehicle communication, and information from a surrounding monitoring system that monitors the positions and movements of nearby pedestrians and vehicles (refer to, for example, Patent Literature 1).

The automatic drive mode is expected to reduce the burden of the driving operation performed by the driver or to ease traffic congestion.

For example, expressways are provided with road-to-vehicle communication, have neither traffic signals nor pedestrians, or have a fixed lane in each direction, and thus mostly allow relatively monotonous driving operations. Expressways are thus suitable for driving in an automatic drive mode. In contrast, ordinary roads are not provided with road-to-vehicle communication, have only one lane in both directions, or have a faded lane, and thus are not suitable for driving in the automatic drive mode.

Thus, a vehicle driver driving in the automatic drive mode along an expressway switches from the automatic drive mode to the manual drive mode before exiting the expressway and entering an ordinary road.

For example, when a vehicle is travelling along an expressway in the automatic drive mode according to a planned route, the vehicle can always determine the distance from the current position to the exit of the expressway and the entry of the ordinary road, and thus can estimate the time taken to exit the expressway and enter the ordinary road based on the current speed. For example, at the time when the time left to enter the ordinary road reaches 60 seconds, the vehicle outputs a voice announcement, such as “The vehicle will shortly enter an ordinary road. Prepare for switching to manual driving in 60 seconds.” A countdown, such as “In 60 seconds.” or “In 59 seconds.” may appear on a screen such as a car navigation system screen, a tablet screen, or a meter screen.

Also, a vehicle traveling along an expressway in the automatic drive mode may no longer continue to travel in the automatic drive mode when an external sensor of the vehicle malfunctions in bad weather, such as fog or heavy rain. In that case, the vehicle determines to discontinue traveling in the automatic drive mode, and outputs a voice announcement such as “Prepare for switching to manual driving in 60 seconds due to bad weather.” Similarly, a countdown, such as “In 60 seconds.” or “In 59 seconds.” typically appears on a screen such as a car navigation system screen, a tablet screen, or a meter screen.

A driver may also intentionally switch from the automatic drive mode to the manual drive mode.

### CITATION LIST

### Patent Literature

Patent Literature 1: Japanese Unexamined Patent Application Publication No. 2015-141053

### SUMMARY

The time taken to prepare for switching from the automatic drive mode to the manual drive mode is set as appropriate individually by, for example, a car manufacturer. The preparation time of 60 seconds described above is a mere example, and is not restrictive. At the time point exceeding the preparation time, the drive mode is switched from the automatic drive mode to the manual drive mode.

However, the time point when the preparation time passes is not always most suitable for switching.

For example, the vehicle may reach the entrance or the exit of a tunnel when the preparation time passes.

At the entrance of a tunnel, the driver is suddenly placed in darkness, and may fail to see the front for a moment. Conversely, at the exit of a tunnel after traveling through the tunnel, the driver is suddenly placed in brightness, and is dazzled and fail to see the front for a moment.

The entrance or the exit of the tunnel at which the view of the driver is significantly degraded is least suitable for switching the drive mode from the automatic drive mode to the manual drive mode. Such switching may rather increase unsafety.

One or more aspects are directed to a drive mode switch controller, a drive mode switch control system, a drive mode switch control method, and a program for, at the time for switching from the automatic drive mode to the manual drive mode, switching when a vehicle is in an appropriate situation, and delaying switching when the vehicle is in an inappropriate situation.

In response to the above issue, one or more aspects are directed to the following devices and method.

A drive mode switch controller according to a first aspect is for outputting a signal for switching a drive mode of a vehicle from an automatic drive mode to a manual drive mode. The controller includes an obtaining unit that obtains sensing data indicating light intensity in a direction in which the vehicle travels measured by a light intensity sensor mounted on the vehicle, and stores the sensing data into a storage, a determination unit that determines, based on the sensing data stored in the storage, whether a surrounding environment in the direction in which the vehicle travels satisfies a predetermined condition appropriate for switching the drive mode in a period predetermined for the switching, and a signal output unit that outputs a signal for performing the switching when the determination unit determines that the surrounding environment in the direction in which the vehicle travels satisfies the predetermined condition.

A drive mode switch controller according to a second aspect is the drive mode switch controller according to a first aspect in which the determination unit compares a rate of change in the light intensity with a predetermined first threshold based on the sensing data stored in the storage in the period, and determines that the surrounding environment in the direction in which the vehicle travels does not satisfy the predetermined condition when the rate of change in the light intensity exceeds the first threshold.

A drive mode switch controller according to a third aspect is the drive mode switch controller according to a first or second aspect in which the signal output unit outputs, to the determination unit, a signal for causing the determination unit to perform the determination again after the determination unit determines that the surrounding environment in the direction in which the vehicle travels does not satisfy the predetermined condition.

A drive mode switch controller according to a fourth aspect is for outputting a signal for switching a drive mode of a vehicle from an automatic drive mode to a manual drive mode. The controller includes an obtaining unit that obtains, from an imaging unit to capture an image of a driver of the vehicle, image data for the captured image of the driver, and stores the image data into a storage, a determination unit that determines whether eyes of the driver identified based on the image data stored in the storage satisfy a predetermined condition appropriate for switching the drive mode in a period predetermined for the switching, and a signal output unit that outputs a signal for performing the switching when the determination unit determines that the eyes of the driver satisfy the predetermined condition.

A drive mode switch controller according to a fifth aspect is the drive mode switch controller according to a fourth aspect in which a determination unit compares a first eye size of the driver identified from the image data for the images captured in the period with a second eye size of the driver identified from the image data for the images captured before the period, and determines that the eyes of the driver do not satisfy the predetermined condition when the first eye size has changed by at least a predetermined amount from the second eye size to degrade visibility.

A drive mode switch controller according to a sixth aspect is the drive mode switch controller according to a fourth aspect in which the determination unit compares a first amount of light around the eyes of the driver identified from the image data for the images captured in the period with a second amount of light around the eyes of the driver identified from the image data for the images captured before the period, and determines that the eyes of the driver do not satisfy the predetermined condition when the first amount of light has changed by at least a predetermined amount from the second amount of light.

A drive mode switch controller according to a seventh aspect is the drive mode switch controller according to a fifth or sixth aspect in which the signal output unit outputs, to the determination unit, a signal for causing the determination unit to perform the determination again after the determination unit determines that the eyes of the driver do not satisfy the predetermined condition.

A drive mode switch control system according to an eighth aspect is for outputting a signal for switching a drive mode of a vehicle from an automatic drive mode to a manual drive mode. The system includes a light intensity sensor mounted on the vehicle, an obtaining unit that obtains sensing data indicating light intensity in a direction in which the vehicle travels measured by the light intensity sensor, and stores the sensing data into a storage, a determination unit that determines, based on the sensing data stored in the storage, whether a surrounding environment in the direction in which the vehicle travels satisfies a predetermined condition appropriate for switching the drive mode in a period predetermined for the switching, and a signal output unit that outputs a signal for performing the switching when the determination unit determines that the surrounding environment in the direction in which the vehicle travels satisfies the predetermined condition.

A drive mode switch control system according to a ninth aspect is for outputting a signal for switching a drive mode of a vehicle from an automatic drive mode to a manual drive mode. The system includes an imaging unit that captures an image of a driver of the vehicle, an obtaining unit that obtains image data for the captured image of the driver from the imaging unit, and stores the image data into a storage, a determination unit that determines whether eyes of the driver identified based on the image data stored in the storage satisfy a predetermined condition appropriate for switching the drive mode in a period predetermined for the switching, and a signal output unit that outputs a signal for performing the switching when the determination unit determines that the eyes of the driver satisfy the predetermined condition.

A drive mode switch control method according to a tenth aspect is for outputting a signal for switching a drive mode of a vehicle from an automatic drive mode to a manual drive mode. The method includes measuring light intensity in a direction in which the vehicle travels with a light intensity sensor mounted on the vehicle, obtaining, with a processor, sensing data indicating light intensity measured by the light intensity sensor, and storing, with the processor, the sensing data into a storage, determining, with the processor, based on the sensing data stored in the storage, whether a surrounding environment in the direction in which the vehicle travels satisfies a predetermined condition appropriate for switching the drive mode in a period predetermined for the switching, and outputting, with the processor, a signal for performing the switching when the surrounding environment in the direction in which the vehicle travels is determined to satisfy the predetermined condition.

A drive mode switch control method according to an eleventh aspect is for outputting a signal for switching a drive mode of a vehicle from an automatic drive mode to a manual drive mode. The method includes capturing an image of a driver of the vehicle with an imaging unit mounted on the vehicle, obtaining, with a processor, image data for the captured image of the driver from the imaging unit, and storing, with the processor, the image data into a storage, determining, with the processor, whether eyes of the driver identified based on the image data stored in the storage satisfy a predetermined condition appropriate for switching the drive mode in a period predetermined for the switching, and outputting, with the processor, a signal for performing the switching when the eyes of the driver are determined to satisfy the predetermined condition.

A program according to a twelfth aspect causes a computer to function as the units included in the drive mode switch controller according to any one of first to seventh aspects.

The drive mode switch controller, the drive mode switch control system, the drive mode switch control method, and the program according to first, eighth, tenth, and twelfth aspects enable switching only when the predetermined condition appropriate for switching is determined to be satisfied based on the light intensity measured by the light intensity sensor at the time for switching from the automatic drive mode to the manual drive mode, and enable safer switching.

In particular, the drive mode switch controller according to a second aspect determines that the driver is in an inappropriate situation for switching when the rate of change in light intensity exceeds a predetermined first threshold.

When determining that the situation does not satisfy the predetermined condition appropriate for switching, the drive mode switch controller according third and seventh aspects delays switching by causing the determination unit to perform determination again. The drive mode switch controller thus avoids switching to the manual drive mode in a dangerous situation, and enables safer switching.

The drive mode switch controller, the drive mode switch control system, and the drive mode switch control method according to fourth, ninth, and eleventh aspects enable switching from the automatic drive mode to the manual drive mode only when the predetermined condition appropriate for switching is determined to be satisfied based on the image data measured by the imaging unit at the time for switching from the automatic drive mode to the manual drive mode, thus enabling safe switching.

In particular, the drive mode switch controller according to a fifth aspect determines that the predetermined condition is not satisfied when the eye size of the driver has changed by at least a predetermined amount to degrade the visibility (e.g., when the driver squints against glaring sunlight) from the eye size of the driver on the image data captured before the time for switching, based on the image data captured at the time for switching. Thus, the drive mode switch controller can delay switching.

The drive mode switch controller according to a sixth aspect determines that the driver is in an inappropriate situation for switching when, after comparing the amount of light around the eyes of the driver obtained from the image data at the time for switching and the amount of light before the time for switching, the change between these amounts is greater than or equal to a predetermined amount. Thus, the drive mode switch controller can delay switching.

### BRIEF DESCRIPTION OF THE DRAWINGS

FIG. 1 is a schematic diagram illustrating an automatic driving control system including a drive mode switch control system according to one or more embodiments.

FIG. 2 is a functional block diagram illustrating a drive mode switch control system according to one or more embodiments.

FIG. 3 is a flow diagram illustrating an operation of a drive mode switch control system according to one or more embodiments.

FIG. 4 is a flow diagram illustrating an operation of a drive mode switch control system according to one or more embodiments.

FIG. 5 is a flow diagram illustrating an operation of a drive mode switch control system according to one or more embodiments.

### DETAILED DESCRIPTION

One or more embodiments will now be described with reference to the drawings.

### Structure

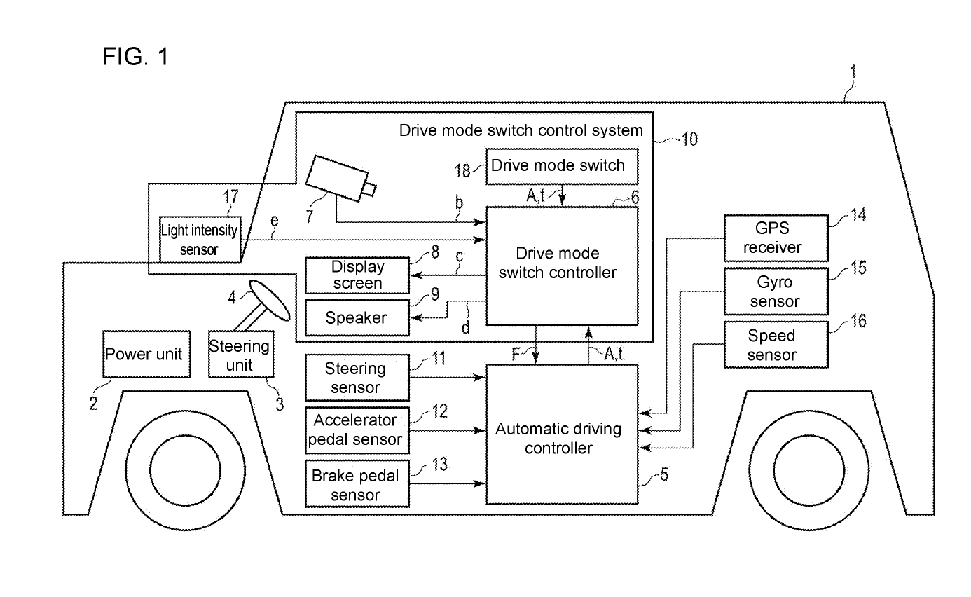

FIG. 1 is a schematic diagram of an automatic driving control system including a drive mode switch control system 10 according to one or more embodiments. The automatic driving control system is mounted on a vehicle 1, such as an automobile.

The vehicle 1 includes, as its basic components, a power unit 2 including a power supply and a transmission, and a steering unit 3 incorporating a steering wheel 4. The vehicle 1 has two drive modes, a manual drive mode and an automatic drive mode. The power supply includes an engine, a motor, or both.

The manual drive mode allows the vehicle 1 to travel mainly based on, for example, a manual driving operation performed by a driver. For example, the manual drive mode includes a vehicle driving operation mode for driving a vehicle with a driving operation performed by a driver alone, and an assisted driving mode for driving a vehicle mainly with a driving operation performed by a driver in combination with assisted driving.

When, for example, the vehicle 1 travels along a curve, assisted driving assists the driver with the steering torque to achieve an appropriate steering quantity based on the curvature of the curve. Assisted driving further includes control for assisting the driver's acceleration (e.g., accelerator pedal operation) or braking (e.g., brake pedal operation), manual steering (manual steering during driving), and manual speed regulation (manual speed control during driving). Manual steering refers to steering the vehicle 1 mainly with the driver's operation on the steering wheel 4. Manual speed regulation refers to adjusting the speed of the vehicle mainly with the driver's accelerating operation or braking operation.

Assisted driving excludes control for forcibly interrupting the driver's driving operation for automatically driving the vehicle. In other words, the manual drive mode reflects the driver's operation on the traveling vehicle within a predetermined allowable range, but excludes any control for forcibly interrupting the vehicle traveling under predetermined conditions (e.g., deviation of the vehicle from a lane).

In contrast, the automatic drive mode enables automatic driving of a vehicle along a road on which the vehicle is traveling. The automatic drive mode includes automatic driving of a vehicle to a predetermined destination without the driver performing a driving operation. The automatic drive mode is not limited to complete automatic control of the vehicle, and includes driving that reflects the driver's operation in the traveling vehicle within a predetermined allowable range. In other words, the automatic drive mode includes control for forcibly interrupting the vehicle travelling under predetermined conditions while reflecting the driver's operation on the traveling vehicle within a predetermined allowable range.

FIG. 1 shows an automatic driving controller 5, which controls driving in the automatic drive mode. The automatic driving controller 5 obtains sensing data from a steering sensor 11, an accelerator pedal sensor 12, a brake pedal sensor 13, a global positioning system (GPS) receiver 14, a gyro sensor 15, and a speed sensor 16. The automatic driving controller 5 automatically controls the travelling of the vehicle 1 based on the sensing data, route information generated by a navigation system (not shown), traffic information obtained through road-to-vehicle communication, and information obtained by a surrounding monitoring system that monitors the positions and movements of nearby pedestrians and vehicles.

The automatic control includes autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane when, for example, the driver is not performing a steering operation. During the operation of LKA, the steering operation of the driver may be reflected in the vehicle steering within the range in which the vehicle 1 stays in the driving lane (allowable range). Autosteering is not limited to LKA.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. During the operation of ACC, the automatic driving controller 5 decelerates the vehicle 1 in response to the driver's braking (e.g., brake pedal operation), or may accelerate the vehicle in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC) that performs constant speed control alone.

An automatic driving control system according to one or more embodiments includes a drive mode switch control system 10, which controls switching between the automatic drive mode and the manual drive mode.

The drive mode switch control system 10 according to one or more embodiments implements a drive mode switch control method featuring the control for switching from the automatic drive mode to the manual drive mode. The control for switching from the automatic drive mode to the manual drive mode will be described below, whereas switching from the manual drive mode to the automatic drive mode will not be described.

The drive mode switch control system 10 includes a drive mode switch controller 6, a drive mode switch 18, a driver camera 7 and a light intensity sensor 17, serving as monitor sensors, and a display screen 8 and a speaker 9, serving as informing devices.

The driver camera 7 is installed in front of a driver, such as on the dashboard, to continuously capture images of the driver during traveling. The driver camera 7 outputs video signals b representing the captured images to the drive mode switch controller 6.

The display screen 8 displays display signals c representing messages output from the drive mode switch controller 6. The display screen 8 may correspond to, for example, a meter of the vehicle 1 or a display screen of a car navigation system mounted on the vehicle 1, but is not limited to these and may for example be a monitor screen of a driving monitor mounted on the vehicle 1.

The speaker 9 outputs sound signal d representing messages output from the drive mode switch controller 6.

The light intensity sensor 17 is installed in front of a windshield. The light intensity sensor 17 continuously detects the light intensity in front of the vehicle 1 during traveling, and outputs a detection signal e to the drive mode switch controller 6.

The drive mode switch 18 is pressed by a driver for requesting switching from the current drive mode. When pressed, the drive mode switch 18 outputs a drive switching request signal A to the drive mode switch controller 6. The drive switching request signal A is accompanied with timing information t indicating switching timing, such as in 60 seconds.

When receiving the drive switching request signal A and the timing information t, the drive mode switch controller 6 starts processing to prepare for switching of the drive mode from the automatic drive mode to the manual drive mode at the predetermined time designated by the timing information t. The drive switching request signal A and the timing information t are not only output in response to the driver pressing the drive mode switch 18, but also output automatically from the automatic driving controller 5, as described later.

For any of the drive switching request signal A and the timing information t output from the drive mode switch 18 or the automatic driving controller 5, the time designated by the timing information t is not limited to 60 seconds, and may be selected by the driver from among predetermined time lengths or may be appropriately set by the driver. For example, the automatic driving controller 5 may set different time lengths in different situations, for example, 60 seconds for switching to the manual drive mode when the vehicle exits an expressway to enter an ordinary road, 30 seconds for switching due to a bad weather, or 4 seconds for switching due to an emergency.

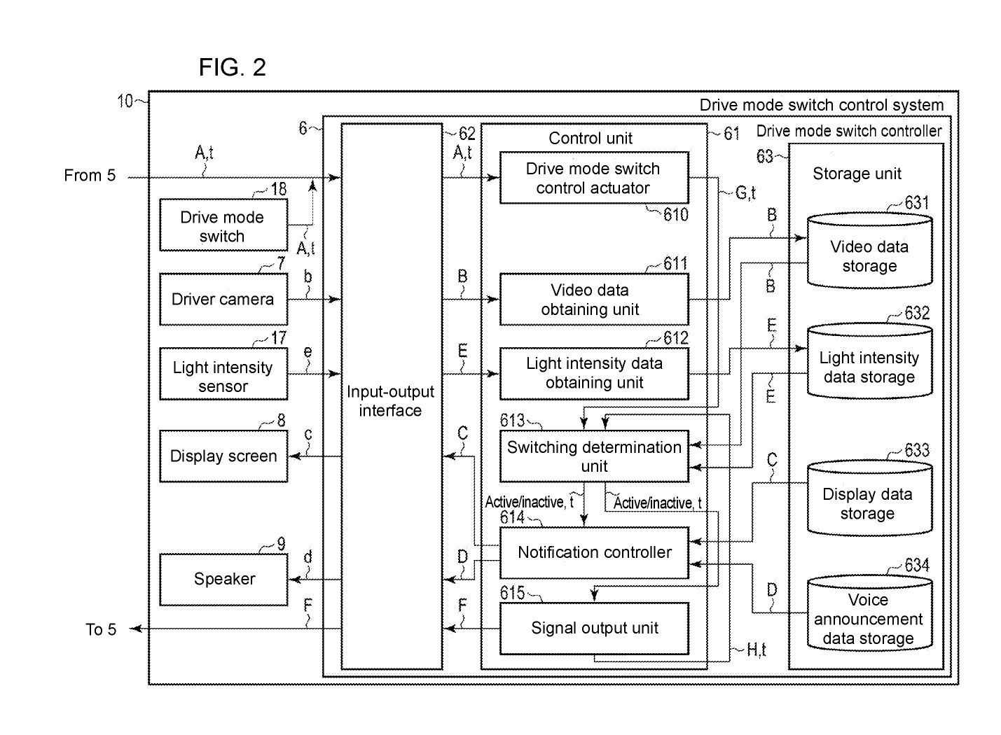

FIG. 2 is a functional block diagram of the drive mode switch control system 10 according to one or more embodiments.

The drive mode switch controller 6 centrally controls the switching between the drive modes, and includes a control unit 61, an input-output interface 62, and a storage unit 63.

The input-output interface 62 receives a drive switching request signal A and timing information t output from the drive mode switch 18 or the automatic driving controller 5, and outputs the drive switching request signal A and the timing information t to the control unit 61. As described above, the drive mode switch 18 outputs the drive switching request signal A and the timing information t when pressed by the driver.

The input-output interface 62 receives the drive switching request signal A and the timing information t, and outputs the drive switching request signal A and the timing information t to the control unit 61.

The input-output interface 62 also receives video signals b output from the driver camera 7, coverts the video signals b into digital data (driver monitoring video data) B, and outputs the digital data B to the control unit 61. The input-output interface 62 also receives detection signals e output from the light intensity sensor 17, converts the detection signals e into sensing data E, and outputs the sensing data E to the control unit 61. The input-output interface 62 converts display data C output from the control unit 61 into display signals c, and outputs the display signals c to the display screen 8. The input-output interface 62 also converts voice announcement data D output from the control unit 61 into sound signals d, and outputs the sound signals d to the speaker 9. The input-output interface 62 also outputs drive mode switch control signals F output from the control unit 61 into the automatic driving controller 5.

The storage unit 63 includes, as a storage medium, a nonvolatile memory, such as a solid state drive (SSD) or a hard disk drive (HDD), which is writable and readable as appropriate. The storage unit 63 includes, as a storage area used for implementing one or more embodiments, a video data storage 631, a light intensity data storage 632, a display data storage 633, and a voice announcement data storage 634.

The control unit 61 includes a central processing unit (CPU) included in a computer and a program memory. The control unit 61 includes, as its control functions for implementing one or more embodiments, a drive mode switch control actuator 610, a video data obtaining unit 611, a light intensity data obtaining unit 612, a switching determination unit 613, a signal output unit 615, and a notification controller 614. These control functions are implemented by the CPU executing programs stored in the program memory.

When receiving the drive switching request signal A and the timing information t output from the input-output interface 62, the drive mode switch control actuator 610 generates an actuation signal G, and outputs the actuation signal G to the switching determination unit 613 together with the timing information t.

The video data obtaining unit 611 stores the digital data (driver monitoring video data) B output from the input-output interface 62 into the video data storage 631. Thus, the driver monitoring video data B representing the state of the driver is stored into the video data storage 631.

The light intensity data obtaining unit 612 stores the sensing data E output from the input-output interface 62 into the light intensity data storage 632. Thus, the sensing data E indicating the light intensity in front of the vehicle 1 is stored into the light intensity data storage 632.

When receiving the actuation signal G and the timing information t output from the drive mode switch control actuator 610, the switching determination unit 613 determines whether to switch the drive mode after the time designated by the timing information t based on the driver monitoring video data B stored in the video data storage 631 and the sensing data E stored in the light intensity data storage 632.

More specifically, the switching determination unit 613 calculates the rate of change in light intensity (e.g., how much the light intensity has changed in 5 seconds) with the sensing data E stored in the light intensity data storage 632 during the period from when receiving the actuation signal G to when the time designated by the timing information t passes. For example, the vehicle 1 entering a tunnel is suddenly in darkness at or around the entrance of the tunnel, greatly increasing the rate of change in light intensity. Similarly, the vehicle 1 exiting a tunnel is suddenly in brightness at or around the exit of the tunnel, greatly increasing the rate of change in light intensity. The light intensity is expected to change suddenly when the vehicle 1 enters or exits from a tunnel. The switching determination unit 613 thus determines that switching at the time designated by the timing information t is inappropriate when the rate of change in light intensity exceeds a predetermined light intensity threshold, and outputs an inactivating signal to the signal output unit 615 and the notification controller 614 together with the timing information t.

The switching determination unit 613 also determines that switching at the time designated by the timing information t is inappropriate when the eye size of the driver is smaller than at the reception of the actuation signal G, that is, when the eye size has changed by at least a predetermined amount in a direction to degrade the visibility, based on the driver monitoring video data B stored in the video data storage 631 during the period from when receiving the actuation signal G to when the time designated by the timing information t passes. The switching determination unit 613 also determines that switching at the time designated by the timing information t is inappropriate when the amount of light around the eyes of the driver has changed by at least a predetermined amount from when receiving the actuation signal G. The switching determination unit 613 then outputs an inactivating signal to the signal output unit 615 and the notification controller 614 together with the timing information t.

The decreasing eye size of the driver may be caused by the driver squinting against glaring sunlight, indicating a situation in which the driver has degraded visibility forward. The switching determination unit 613 determines that switching is inappropriate in this situation. A high rate of change in the amount of light around the driver's eyes corresponds to a sudden change to bright or dark surroundings. The switching determination unit 613 thus determines that switching is inappropriate in this situation.

Although the switching determination unit 613 uses the driver monitoring video data B and the sensing data E to determine whether the driver is in an appropriate situation for switching in the example described above, the switching determination unit 613 may use one of the driver monitoring video data B and the sensing data E, or use either the driver monitoring video data B or the sensing data E with priority over the other.

The switching determination unit 613 determines that the driver is in an appropriate situation for switching except for the above situation, that is, except when outputting an inactivating signal, and outputs an activating signal to the signal output unit 615 and the notification controller 614 when the time designated by the timing information t passes.

When receiving the activating signal from the switching determination unit 613, the signal output unit 615 outputs a drive mode switch control signal F for switching the drive mode from the automatic drive mode to the manual drive mode to the input-output interface 62. As described above, the input-output interface 62 outputs the drive mode switch control signal F to the automatic driving controller 5. When receiving the drive mode switch control signal F, the automatic driving controller 5 switches the drive mode from the automatic drive mode to the manual drive mode.

When receiving the inactivating signal and the timing information t from the switching determination unit 613, the signal output unit 615 outputs a redetermination instruction signal H together with the timing information t to the switching determination unit 613.

When receiving the redetermination instruction signal H and the timing information t from the signal output unit 615, the switching determination unit 613 performs the above determination again using the timing information t. In response to the determination result, the switching determination unit 613 outputs either an activating signal, or an inactivating signal and timing information t to the signal output unit 615.

In response to the signal output from the switching determination unit 613, the notification controller 614 obtains appropriate display data C from the display data storage 633, obtains appropriate voice announcement data D from the voice announcement data storage 634, and outputs the data C and the data D to the input-output interface 62.

The display data storage 633 stores various sets of display data C. New sets of display data C may be additionally stored into the display data storage 633 or the existing sets of display data C stored in the display data storage 633 may be updated to define various sets of display data.

The voice announcement data storage 634 stores various sets of voice announcement data D. New sets of voice announcement data D may be additionally stored into the voice announcement data storage 634, or the existing sets of voice announcement data D stored in the voice announcement data storage 634 may be updated to define various sets of voice announcement data.

When receiving the activating signal output from the switching determination unit 613, the notification controller 614 obtains, from the display data storage 633, the display data C for displaying a message “Switching to automatic drive mode.” on the display screen 8, obtains, from the voice announcement data storage 634, the voice announcement data D for outputting a message “Switching to automatic drive mode.” from the speaker 9, and outputs the data C and the data D to the input-output interface 62.

When receiving the inactivating signal and the timing information t from the switching determination unit 613, the notification controller 614 obtains, from the display data storage 633, the display data C for displaying a message “Unable to switch to automatic drive mode. Retrying in t seconds.” on the display screen 8, and obtains, from the voice announcement data storage 634, the voice announcement data D for outputting a message “Unable to switch to automatic drive mode. Retrying in t seconds.” from the speaker 9, and outputs the data C and the data D to the input-output interface 62.

The input-output interface 62 converts the display data C output from the notification controller 614 into the display signals c, and outputs the display signals c to the display screen 8. The input-output interface 62 converts the voice announcement data D output from the notification controller 614 into a sound signal d, and outputs the sound signal d to the speaker 9. Thus, the display screen 8 displays a message represented by the display data C, and the speaker 9 outputs a voice announcement represented by the voice announcement data D.

The drive mode switch control system 10 thus determines whether the driver at the time designated by the timing information t is in an appropriate situation for switching from the automatic drive mode to the manual drive mode, and enables switching when the driver is determined to be in an appropriate situation for switching. When determining that the driver is in an inappropriate situation for switching, the drive mode switch control system 10 delays switching from the automatic drive mode to the manual drive mode until the switching determination unit 613 repeats the determination and determines that the driver is in an appropriate situation.

### Operation

The operation of the drive mode switch control system 10 according to one or more embodiments with the above structure will now be described.

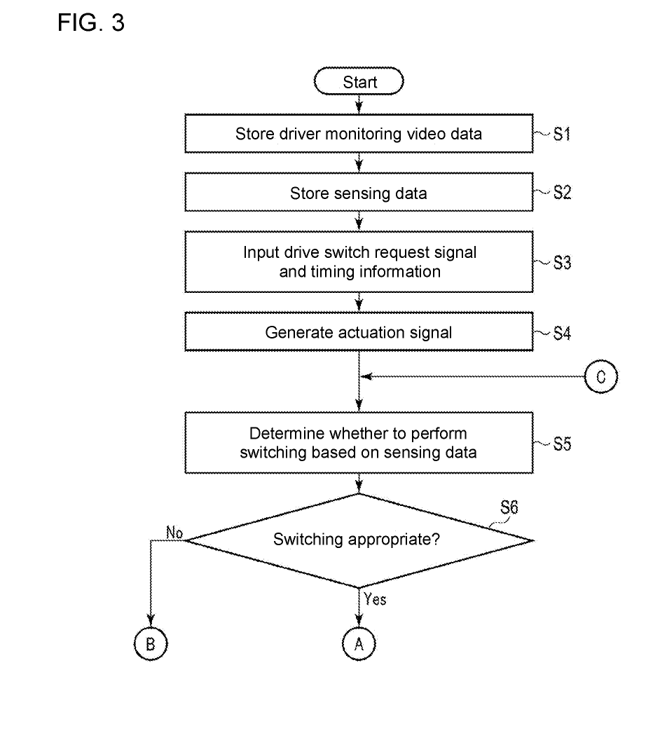

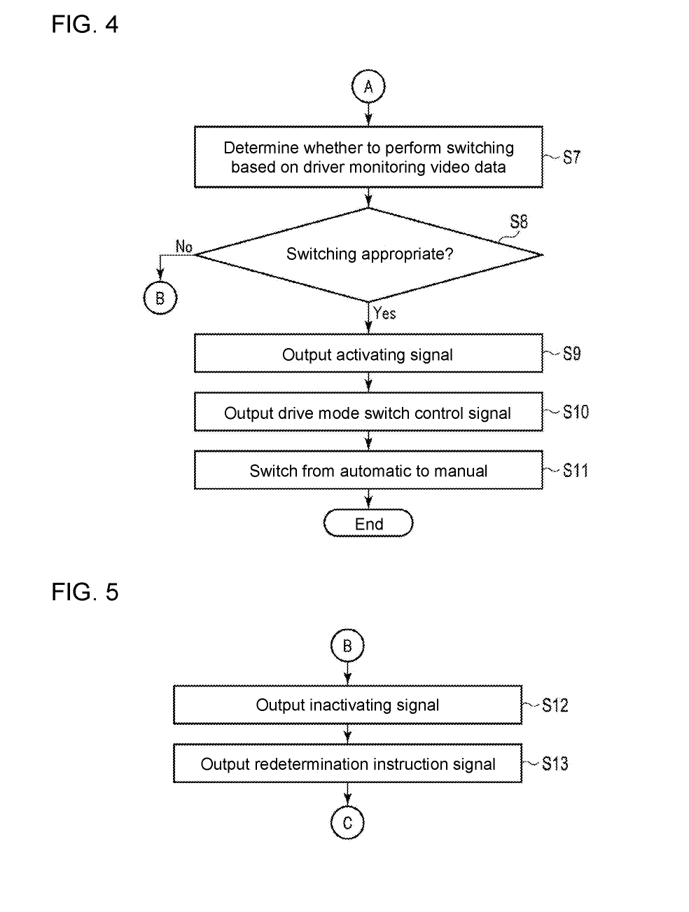

FIGS. 3 to 5 are flowcharts showing the operation of the drive mode switch control system 10 according to one or more embodiments.

The vehicle 1 is operated in the automatic drive mode by the automatic driving controller 5. In the automatic drive mode, the drive mode switch control system 10 operates the driver camera 7 installed in front of a driver, such as on the dashboard, to continuously capture images of the driver during traveling. The video signals b are output to the drive mode switch controller 6. The video signals b are converted by the input-output interface 62 into digital data (driver monitoring video data) B, which is then stored into the video data storage 631 by the video data obtaining unit 611 (S1).

The drive mode switch control system 10 also operates the light intensity sensor 17 installed in front of the windshield to continuously detect the light intensity in front of the vehicle 1 during traveling, and outputs detection signals e to the drive mode switch controller 6. The detection signals e are converted by the input-output interface 62 into the sensing data E, which is then stored into the light intensity data storage 632 by the light intensity data obtaining unit 612 (S2).

To switch the drive mode from the automatic drive mode to the manual drive mode, the drive mode switch control system 10 receives the drive switching request signal A and the timing information t (S3). The drive switching request signal A and the timing information t are output from the drive mode switch 18 in response to the driver pressing the drive mode switch 18, or output from the automatic driving controller 5.

The drive switching request signal A and the timing information t are received by the drive mode switch control actuator 610. In response to these, the drive mode switch control actuator 610 generates an actuation signal G, which is then output to the switching determination unit 613 together with the timing information t (S4).

When receiving the actuation signal G and the timing information t, the switching determination unit 613 determines whether to switch the drive mode after the time designated by the timing information t based on the driver monitoring video data B stored in the video data storage 631 and the sensing data E stored in the light intensity data storage 632 (S5).

More specifically, the switching determination unit 613 calculates the rate of change in light intensity using the sensing data E stored in the light intensity data storage 632 during the period from when receiving the actuation signal G to when the time designated by the timing information t passes. For example, the driver is inappropriate for switching in a situation in which the light intensity is suddenly changed, such as at or around the exit or entrance of a tunnel. Thus, when the rate of change in light intensity exceeds a predetermined light intensity threshold, the switching determination unit 613 determines that the driver is in an inappropriate situation for switching (No in S6) at the time designated by the timing information t, and outputs an inactivating signal together with the timing information t to the signal output unit 615 and the notification controller 614 (S12).

The switching determination unit 613 also performs determination using the driver monitoring video data B stored in the video data storage 631 during the period from when receiving the actuation signal G to when the time designated by the timing information t passes when the driver is determined to be in an appropriate situation for switching (Yes in S6) in the determination in step S6 using the rate of change in light intensity (S7).

In the determination in step S7, when the driver's eye size is smaller than when receiving the actuation signal G, that is, when the driver's eye size has changed by at least a predetermined amount to degrade the visibility, or when the amount of light around the eyes of the driver has changed by at least a predetermined amount from when receiving the actuation signal G, the switching determination unit 613 determines that the driver is in an inappropriate situation for switching (No in S8) at the time designated by the timing information t. In this case, the switching determination unit 613 outputs an inactivating signal to the signal output unit 615 and the notification controller 614 together with the timing information t (S12).

The driver squinting means the driver dazzled by glaring sunlight and having degraded visibility forward. A high rate of change in the amount of light around the driver's eyes means the driver suddenly placed in brightness or darkness, and similarly having degraded visibility forward.

For ease of explanation, the determination based on the sensing data E (S5 and S6) precedes the determination based on the driver monitoring video data B (S7 and S8) in one or more embodiments. However, the determinations may be performed in the opposite order or may be performed in parallel. In one or more embodiments, the switching determination may be performed using one of the driver monitoring video data B and the sensing data E or using either the driver monitoring video data B or the sensing data E with priority over the other.

The processing in steps S1 and S2 is constantly performed in parallel when the processing from step S3 and subsequent steps is performed.

The switching determination unit 613 determines that the driver is in an appropriate situation for switching except when outputting an inactivating signal (Yes in S8), and outputs an activating signal to the signal output unit 615 and the notification controller 614 when the time designated by the timing information t passes (S9).

In response to the activating signal from the switching determination unit 613, the signal output unit 615 outputs the drive mode switch control signal F for switching the drive mode from the automatic drive mode to the manual drive mode to the input-output interface 62, and the input-output interface 62 outputs the drive mode switch control signal F to the automatic driving controller 5 (S10).

In response to the activating signal from the switching determination unit 613, the notification controller 614 obtains, from the display data storage 633, the display data C for displaying a message “Switching to automatic drive mode.” on the display screen 8, obtains, from the voice announcement data storage 634, the voice announcement data D for outputting a message “Switching to automatic drive mode.” from the speaker 9, and outputs the data C and the data D to the input-output interface 62.

In response to this, the input-output interface 62 outputs the display signal c to the display screen 8, and the display screen 8 displays a message “Switching to automatic drive mode.” The input-output interface 62 also outputs the sound signal d to the speaker 9, and the speaker 9 outputs a voice announcement “The vehicle is shortly switched to automatic drive mode.”

In response to the drive mode switch control signal F, the automatic driving controller 5 switches the drive mode from the automatic drive mode to the manual drive mode (S11).

When receiving the inactivating signal and the timing information t from the switching determination unit 613 in step S12, the signal output unit 615 outputs the redetermination instruction signal H together with the timing information t to the switching determination unit 613 (S13).

In response to the inactivating signal and the timing information t from the switching determination unit 613, the notification controller 614 obtains, from the display data storage 633, the display data C for displaying a message “Unable to switch to automatic drive mode. Retrying in t seconds.” on the display screen 8, obtains, from the voice announcement data storage 634, the voice announcement data D for outputting a message “Unable to switch to automatic drive mode. Retrying in t seconds.” from the speaker 9, and outputs the data C and the data D to the input-output interface 62.

In response to this, the input-output interface 62 outputs the display signal c to the display screen 8, and the display screen 8 displays the message “Unable to switch to automatic drive mode. Retrying in t seconds.” The input-output interface 62 also outputs the sound signal d to the speaker 9, and the speaker 9 outputs the voice announcement “Unable to switch to automatic drive mode. Retrying in t seconds.”

In response to the redetermination instruction signal H and the timing information t output in step S13, the switching determination unit 613 repeats the processing from step S5 and subsequent steps using the timing information t.

Thus, the drive mode switch control system 10 determines whether the driver at the time designated by the timing information t is in an appropriate situation for switching from the automatic drive mode to the manual drive mode, and enables switching when determining that the driver is in an appropriate situation for switching. The drive mode switch control system 10 delays switching from the automatic drive mode to the manual drive mode when determining that the driver is in an inappropriate situation for switching until the switching determination unit 613 repeats the determination and determines that the driver is in an appropriate situation.

As described above, instead of automatically switching from the automatic drive mode to the manual drive mode at designated timings in response to requests for switching, the drive mode switch control system according to one or more embodiments determines whether the driver is in an appropriate situation for switching in a predetermined period, and enables or delays the switching depending on the determination result.

When the driver is in an inappropriate situation for switching, such as at or around the exit or entrance of a tunnel, the drive mode switch control system retains the automatic driving and delays the switching. The drive mode switch control system thus avoids switching to the manual drive mode in a dangerous situation, and enables safer switching.

### Modification 1

The drive mode switch control system according to one or more embodiments determines that the vehicle 1 reaches the entrance or the exit of a tunnel based on the driver monitoring video data B from the driver camera 7 or the sensing data E from the light intensity sensor 17.

However, instead of or in addition to such data, the drive mode switch control system according to the modification may determine that the vehicle 1 reaches the entrance or the exit of a tunnel based on images captured by a front camera mounted on the vehicle 1.

More specifically, in response to the actuation signal G and the timing information t output from the drive mode switch control actuator 610, the switching determination unit 613 starts analyzing video data representing the images captured by the front camera. When identifying the entrance or the exit of a tunnel in front, the switching determination unit 613 outputs an inactivating signal and timing information t to the signal output unit 615.

As in one or more embodiments, the drive mode switch control system according to the modification disables switching to the manual drive mode at the entrance or the exit of a tunnel and delays the switching, and thus avoids switching in a dangerous situation, such as at the entrance or the exit of a tunnel, and enables safer switching.

### Modification 2

The drive mode switch control system according to one or more embodiments determines that the vehicle 1 reaches the entrance or the exit of a tunnel based on the driver monitoring video data B from the driver camera 7 or the sensing data E from the light intensity sensor 17. Instead of or in addition to such data, the drive mode switch control system according to modification 1 determines that the vehicle 1 reaches the entrance or the exit of a tunnel based on images captured by the front camera.

However, instead of or in addition to such data, the drive mode switch control system according to an aspect may determine that the vehicle 1 reaches the entrance or the exit of a tunnel based on map information fed by a car navigation system mounted on the vehicle 1.

More specifically, when receiving an actuation signal G and timing information t output from the drive mode switch control actuator 610, the switching determination unit 613 refers to map information provided by a car navigation system to determine the position of the vehicle 1. The switching determination unit 613 then outputs an inactivating signal and timing information t to the signal output unit 615 when the vehicle is reaching the entrance or the exit of a tunnel at the time designated by the timing information t.

As in one or more embodiments and modification 1, the drive mode switch control system according to the modification disables switching to the manual drive mode at the entrance or the exit of a tunnel and delays the switching, and thus avoids switching in a dangerous situation, such as at the entrance or the exit of a tunnel, and enables safer switching.

Although embodiments have been described with reference to the appended drawings, the present invention is not limited to the above embodiments. Variations and modifications may occur to those skilled in the art within the spirit and scope of the present invention defined by the claims. Such variations and modifications can fall within the technical scope of the present invention.

One or more embodiments may be partially or entirely expressed in, but not limited to, the following forms shown in the appendixes below.

### APPENDIX 1

A drive mode switch controller for outputting a signal for switching a drive mode of a vehicle from an automatic drive mode to a manual drive mode, the controller comprising a processor and a memory,

the memory including a storage storing sensing data indicating light intensity in a direction in which the vehicle travels measured by a light intensity sensor mounted on the vehicle,

the processor being configured to

determine, based on the sensing data stored in the storage, whether a surrounding environment in a direction in which the vehicle travels satisfies a predetermined condition appropriate for switching the drive mode in a period predetermined for the switching, and

output a signal for performing the switching when the surrounding environment in the direction in which the vehicle travels is determined to satisfy the predetermined condition,

wherein the determination includes comparing a rate of change in light intensity with a predetermined first threshold based on the sensing data stored in the storage in the period, and determining that the surrounding environment in the direction in which the vehicle travels does not satisfy the predetermined condition when the rate of change in the light intensity exceeds the first threshold.

### APPENDIX 2

A drive mode switch controller for outputting a signal for switching a drive mode of a vehicle from an automatic drive mode to a manual drive mode, the controller comprising a processor and a memory,

the memory including a storage for storing image data for an image of a driver of the vehicle captured by an imaging unit configured to capture the image of the driver, the processor being configured to

determine whether eyes of the driver identified based on the image data stored in the storage satisfy a predetermined condition appropriate for switching the drive mode in a period predetermined for the switching, and

output a signal for performing the switching when determining that the eyes of the driver satisfy the predetermined condition,

wherein the determination includes comparing a first amount of light around the eyes of the driver identified from the image data for the images captured in the period with a second amount of light around the eyes of the driver identified from the image data for the images captured before the period, and determining that the eyes of the driver do not satisfy the predetermined condition when the first amount of light has changed by at least a predetermined amount from the second amount of light.

### APPENDIX 3

A drive mode switch control system for outputting a signal for switching a drive mode of a vehicle from an automatic drive mode to a manual drive mode, the system comprising a light intensity sensor mounted on the vehicle, a processor, and a memory,

the memory including a storage for storing sensing data indicating light intensity in a direction in which the vehicle travels measured by the light intensity sensor,

the processor being configured to

determine, based on the sensing data stored in the storage, whether a surrounding environment in the direction in which the vehicle travels satisfies a predetermined condition appropriate for switching the drive mode in a period predetermined for the switching, and

output a signal for performing the switching when determining that the surrounding environment in the direction in which the vehicle travels satisfies the predetermined condition,

wherein the determination includes comparing a rate of change in the light intensity with a predetermined first threshold based on the sensing data stored in the storage in the period, and determining that the surrounding environment in the direction in which the vehicle travels does not satisfy the predetermined condition when the rate of change in the light intensity exceeds the first threshold.

### APPENDIX 4

A drive mode switch control system for outputting a signal for switching a drive mode of a vehicle from an automatic drive mode to a manual drive mode, the system comprising an imaging unit configured to capture an image of a driver of the vehicle, a processor, and a memory,

the memory including a storage for storing image data for the captured image of the driver from the imaging unit,

the processor being configured to

determine whether eyes of the driver identified based on the image data stored in the storage satisfy a predetermined condition appropriate for switching the drive mode in a period predetermined for the switching, and

output a signal for performing the switching when determining that the eyes of the driver satisfy the predetermined condition,

wherein the determination includes comparing a first amount of light around the eyes of the driver identified from the image data for the images captured in the period with a second amount of light around the eyes of the driver identified from the image data for the images captured before the period, and determining that the eyes of the driver do not satisfy the predetermined condition when the first amount of light has changed by at least a predetermined amount from the second amount of light.

### APPENDIX 5

A drive mode switch control method for outputting a signal for switching a drive mode of a vehicle from an automatic drive mode to a manual drive mode, the method comprising:

measuring light intensity in a direction in which the vehicle travels with a light intensity sensor mounted on the vehicle;

storing, with a processor, sensing data indicating light intensity measured by the light intensity sensor in a memory;

determining, with the processor, based on the sensing data stored in the memory, whether a surrounding environment in the direction in which the vehicle travels satisfies a predetermined condition appropriate for switching the drive mode in a period predetermined for the switching; and

outputting, with the processor, a signal for performing the switching when the surrounding environment in the direction in which the vehicle travels is determined to satisfy the predetermined condition,

wherein the determination includes comparing a rate of change in the light intensity with a predetermined first threshold based on the sensing data stored in the memory in the period, and determining that the surrounding environment in the direction in which the vehicle travels does not satisfy the predetermined condition when the rate of change in the light intensity exceeds the first threshold.

### APPENDIX 6

A drive mode switch control method for outputting a signal for switching a drive mode of a vehicle from an automatic drive mode to a manual drive mode, the method comprising:

capturing an image of a driver of the vehicle with an imaging unit mounted on the vehicle;

storing, with a processor, image data for the captured image of the driver from the imaging unit in a memory;

determining, with the processor, whether eyes of the driver identified based on the image data stored in the memory satisfy a predetermined condition appropriate for switching the drive mode in a period predetermined for the switching; and

outputting, with the processor, a signal for performing the switching when the eyes of the driver are determined to satisfy the predetermined condition,

wherein the determination includes comparing a first amount of light around the eyes of the driver identified from the image data for the images captured in the period with a second amount of light around the eyes of the driver identified from the image data for the images captured before the period, and determining that the eyes of the driver do not satisfy the predetermined condition when the first amount of light has changed by at least a predetermined amount from the second amount of light.

1. A drive mode switch controller for outputting a signal for switching a drive mode of a vehicle from an automatic drive mode to a manual drive mode, the controller comprising a processor configured with a program to perform operations comprising:
operation as an obtaining unit configured to obtain sensing data indicating light intensity in a direction in which the vehicle travels measured by a light intensity sensor mounted on the vehicle, and to store the sensing data into a storage;
operation as a determination unit configured to determine, based on the sensing data stored in the storage, whether a surrounding environment in the direction in which the vehicle travels satisfies a predetermined condition appropriate for switching the drive mode in a period predetermined for the switching; and
operation as a signal output unit configured to output a signal for performing the switching in response to a determination, by operation as the determination unit, that the surrounding environment in the direction in which the vehicle travels satisfies the predetermined condition, wherein
the processor is configured with the program to perform operations such that operation as the determination unit is further configured to compare a rate of change in the light intensity with a predetermined first threshold based on the sensing data stored in the storage in the period, and to determine that the surrounding environment in the direction in which the vehicle travels does not satisfy the predetermined condition in response to the rate of change in the light intensity exceeding the first threshold.

2. The drive mode switch controller according to claim 1, wherein
the processor is configured with the program to perform operations such that operation as the signal output unit is further configured to output a signal for causing operation as the determination unit to perform the determination again after operation as the determination unit determines that the surrounding environment in the direction in which the vehicle travels does not satisfy the predetermined condition.

3. A drive mode switch controller for outputting a signal for switching a drive mode of a vehicle from an automatic drive mode to a manual drive mode, the controller comprising a processor configured with a program to perform operations comprising:
operation as an obtaining unit configured to obtain, from an imaging unit configured to capture an image of a driver of the vehicle, image data for the captured image of the driver, and to store the image data into a storage;
operation as a determination unit configured to determine whether eyes of the driver identified based on the image data stored in the storage satisfy a predetermined condition appropriate for switching the drive mode in a period predetermined for the switching; and
operation as a signal output unit configured to output a signal for performing the switching in response to a determination, by operation as the determination unit, that the eyes of the driver satisfy the predetermined condition, wherein
the processor is configured with the program to perform operations such that operation as the determination unit is further configured to compare a first amount of light around the eyes of the driver identified from the image data for the images captured in the period with a second amount of light around the eyes of the driver identified from the image data for the images captured before the period, and to determine that the eyes of the driver do not satisfy the predetermined condition in response to the first amount of light having changed by at least a predetermined amount from the second amount of light.

4. The drive mode switch controller according to claim 3, wherein
the processor is configured with the program to perform operations such that operation as the determination unit is further configured to compare a first eye size of the eyes of the driver identified from the image data for the images captured in the period with a second eye size of the eyes of the driver identified from the image data for the images captured before the period, and to determine that the eyes of the driver do not satisfy the predetermined condition in response to the first eye size having changed by at least a predetermined amount from the second eye size to degrade visibility.

5. The drive mode switch controller according to claim 3, wherein
the processor is configured with the program to perform operations such that operation as the signal output unit is further configured to output a signal for causing operation as the determination unit to perform the determination again after the determination unit determines that the eyes of the driver do not satisfy the predetermined condition.

6. The drive mode switch controller according to claim 4, wherein
the processor is configured with the program to perform operations such that operation as the signal output unit is further configured to output a signal for causing operation as the determination unit to perform the determination again after the determination unit determines that the eyes of the driver do not satisfy the predetermined condition.

7. A drive mode switch control system for outputting a signal for switching a drive mode of a vehicle from an automatic drive mode to a manual drive mode, the system comprising:
a light intensity sensor mounted on the vehicle;
a processor configured with a program to perform operations comprising:
operation as an obtaining unit configured to obtain sensing data indicating light intensity in a direction in which the vehicle travels measured by the light intensity sensor, and to store the sensing data into a storage;
operation as a determination unit configured to determine, based on the sensing data stored in the storage, whether a surrounding environment in the direction in which the vehicle travels satisfies a predetermined condition appropriate for switching the drive mode in a period predetermined for the switching; and
operation as a signal output unit configured to output a signal for performing the switching in response to a determination, by operation as the determination unit, that the surrounding environment in the direction in which the vehicle travels satisfies the predetermined condition, wherein
the processor is configured with the program to perform operations such that operation as the determination unit is further configured to compare a rate of change in the light intensity with a predetermined first threshold based on the sensing data stored in the storage in the period, and to determine that the surrounding environment in the direction in which the vehicle travels does not satisfy the predetermined condition in response to the rate of change in the light intensity exceeding the first threshold.

8. A drive mode switch control system for outputting a signal for switching a drive mode of a vehicle from an automatic drive mode to a manual drive mode, the system comprising a processor configured with a program to perform operations comprising:
operation as an imaging unit configured to capture an image of a driver of the vehicle;
operation as an obtaining unit configured to obtain image data for the captured image of the driver from the imaging unit, and store the image data into a storage;
operation as a determination unit configured to determine whether eyes of the driver identified based on the image data stored in the storage satisfy a predetermined condition appropriate for switching the drive mode in a period predetermined for the switching; and
operation as a signal output unit configured to output a signal for performing the switching in response to a determination, by operation by the determination unit, that the eyes of the driver satisfy the predetermined condition, wherein
the processor is configured with the program to perform operations such that operation as the determination unit is further configured to compare a first amount of light around the eyes of the driver identified from the image data for the images captured in the period with a second amount of light around the eyes of the driver identified from the image data for the images captured before the period, and to determine that the eyes of the driver do not satisfy the predetermined condition in response to the first amount of light having changed by at least a predetermined amount from the second amount of light.

9. A drive mode switch control method for outputting a signal for switching a drive mode of a vehicle from an automatic drive mode to a manual drive mode, the method comprising:
measuring light intensity in a direction in which the vehicle travels with a light intensity sensor mounted on the vehicle;
obtaining, with a processor, sensing data indicating light intensity measured by the light intensity sensor, and storing, with the processor, the sensing data into a storage;
determining, with the processor, based on the sensing data stored in the storage, whether a surrounding environment in the direction in which the vehicle travels satisfies a predetermined condition appropriate for switching the drive mode in a period predetermined for the switching; and
outputting, with the processor, a signal for performing the switching in response to determining that the surrounding environment in the direction in which the vehicle travels satisfies the predetermined condition, wherein
the determining comprises comparing a rate of change in the light intensity with a predetermined first threshold based on the sensing data stored in the storage in the period, and determining that the surrounding environment in the direction in which the vehicle travels does not satisfy the predetermined condition in response to the rate of change in the light intensity exceeding the first threshold.

10. A drive mode switch control method for outputting a signal for switching a drive mode of a vehicle from an automatic drive mode to a manual drive mode, the method comprising:
capturing an image of a driver of the vehicle with an imaging unit mounted on the vehicle;
obtaining, with a processor, image data for the captured image of the driver from the imaging unit, and storing, with the processor, the image data into a storage;
determining, with the processor, whether eyes of the driver identified based on the image data stored in the storage satisfy a predetermined condition appropriate for switching the drive mode in a period predetermined for the switching; and
outputting, with the processor, a signal for performing the switching in response to determining that the eyes of the driver satisfies the predetermined condition, wherein
the determining comprises comparing a first amount of light around the eyes of the driver identified from the image data for the images captured in the period with a second amount of light around the eyes of the driver identified from the image data for the images captured before the period, and determining that the eyes of the driver do not satisfy the predetermined condition in response to the first amount of light having changed by at least a predetermined amount from the second amount of light.

11. A non-transitory computer-readable storage medium storing a program, which when read and executed, causes a computer to perform operations comprising the operations of the drive mode switch controller according to claim 1.

12. A non-transitory computer-readable storage medium storing a program, which when read and executed, causes a computer to perform operations comprising the operations of the drive mode switch controller according to claim 2.

13. A non-transitory computer-readable storage medium storing a program, which when read and executed, causes a computer to perform operations comprising the operations of the drive mode switch controller according to claim 3.

14. A non-transitory computer-readable storage medium storing a program, which when read and executed, causes a computer to perform operations comprising the operations of the drive mode switch controller according to claim 4.

15. A non-transitory computer-readable storage medium storing a program, which when read and executed, causes a computer to perform operations comprising the operations of the drive mode switch controller according to claim 5.

16. A non-transitory computer-readable storage medium storing a program, which when read and executed, causes a computer to perform operations comprising the operations of the drive mode switch controller according to claim 6.
